(19) United States
(12) Patent Application Publication
(10) Pub. No.: US 2007/0268629 A1
(43) Pub. Date: Nov. 22, 2007

(54) Suspension Buckling Limiter

(75) Inventors: Jerry Coffey, Longmont, CO (US); John Harris, Boulder, CO (US); Getachew Asefaw, Denver, CO (US); Gale Johnson, Loveland, CO (US)

Correspondence Address: SHERIDAN ROSS PC, 1560 BROADWAY, SUITE 1200, DENVER, CO, 80202, US

(73) Assignee: SEAGATE TECHNOLOGY LLC, Scotts Valley, CA (US)

(21) Appl. No.: 11/560,229

(22) Filed: Nov. 15, 2006

Related U.S. Application Data
(60) Provisional application No. 60/747,549, filed on May 18, 2006.

(51) Int. Cl. G11B 5/48

(52) U.S. Cl. 360/245.7

(57) ABSTRACT

Apparatuses and a method are provided to prevent buckling damage to a disk drive flexure when the read/write heads are subjected to high stiction loads and when backward rotation of the disks occur. Excessive flexure displacements due to the buckling loads are prevented by transferring some of the force of the buckling load to the stronger, stiffer load beam. Buckling limiter features are provided on either the load beam or flexure, or on both the load beam and flexure wherein the force of the buckling load causes contact of a component on the flexure against a component on the load beam. The contact between the components causes some of the buckling load to be transferred to the load beam. Each of the preferred embodiments provide different structural components forming the buckling limiting features.

### CROSS REFERENCE TO RELATED APPLICATIONS

Priority is claimed from the U.S. Provisional Patent Application Number 60,747,549 filed on May 18, 2006, and entitled “SUSPENSION BUCKLING LIMITER” and further identified as Attorney Docket No. 3123-929-PROV, the disclosure of which is incorporated herein by reference in its entirety.

### FIELD OF THE INVENTION

The present invention relates to magnetic storage devices and, more particularly, to apparatuses and a method of limiting buckling failure of disk drive suspensions caused by stiction and by backwards rotation of the magnetic disks with respect to the actuator suspension.

### BACKGROUND OF THE INVENTION

Magnetic storage devices such as disk drives typically incorporate retrieval and storage of data by use of magnetic storage disks and read/write heads that are capable of reading data from and writing data to the rotating storage disks. Data is stored on each magnetic storage disk in a number of concentric tracks on the disk. The more narrow the tracks can be made, the more data that can be stored on the storage disk. The read/write heads may also be referred to as the read/write transducers that are integrated within a slider which typically places the heads at a predetermined flying height above the corresponding storage disk. One or more read/write heads may be integrated within a single slider. A flexure supports the slider over the disk and maintains the slider over the desired data track centerline during a read or write operation. A cushion of air is generated between the slider and the rotating disk, the cushion often referred to as an air bearing. The suspension is attached to the arm of the actuator which is the component in the disk drive for positioning the read/write heads. The actuator is typically controlled by a voice coil motor that acts as the primary means for positioning of the slider over the desired track. The suspension or suspension assembly may collectively refer to the flexture, load beam, and swage plate that interconnects the suspension to the actuator.

One known cause of read/write errors that may occur is caused by a phenomenon known as stiction. The slider has a tendency to adhere to the disk surface when the read/write heads are at rest on the disk. Stiction can be caused by a number of factors to include migration of disk surface lubricant into the head/disk interface. A liquid lubricant may be applied to the disk surface to increase the wear resistance of the head/disk interface. Any other liquids or lubricants used for other components in the disk drive may also migrate onto the head/disk interface thus exacerbating stiction problems. Out-gassing may result in the formation of adhesive-like materials on the disk surface thereby increasing stiction loads. For the higher magnetic recording densities found in disk drives, the flying height of the heads over the disk is decreased. Accordingly, disk and head surfaces have to be very smooth to minimize head/disk contact while the drive is in operation. Generally, the smoother disk surfaces cause larger contact areas between the heads and disk surfaces, thereby creating higher stiction at the head/disk interface.

Because of the general trend toward miniaturization of disk drives and components, the problem of reducing stiction at the head/disk interface is made more difficult because the size of the spindle motor and power output of the motor have been reduced to a point where the power of the disk drive upon startup may not be able to overcome stiction loads. Also as a result of the miniaturization of disk drive components, the thickness and size of a flexure is reduced. Thus, the flexure is more susceptible to damage by buckling forces generated by stiction.

Two references that disclose solutions for overcoming stiction conditions in a disk drive include the U.S. Pat. Nos. 5,801,505 and 6,587,299.

Another cause of damage by buckling forces is the backward rotation of the disks relative to the flexure. Backward rotation of the disks can be caused by a number of events to include rotational shock, such as a disk drive that is inadvertently dropped. Another cause of backward rotation of the disks relative to the flexure is the startup of the spindle motor. Misalignment of the motor stators and poles may inherently result in a small degree of backward rotation. The degree of backward rotation is dependent upon a number of factors to include the particular motor construction and the motor's start algorithm.

One well-known way to deal with stiction loading as well as backward rotation of the disks is to design the disk drive to be a load/unload drive so that the heads are not parked on the disk during shipment, drive startup, or non-operational shock events. However, one of the disadvantages of a load/unload drive is seek time performance. For server drives that require high data transfer rates, designing a server as a load/unload drive is unacceptable because of the delayed seek time performance. Thus, particularly for server drives, some other solution must be provided to prevent damaging stiction loads and backward rotation of the disks.

Given that stiction and backward rotation of the disks are not completely preventable, some additional protection needs to be provided by preventing the possibility of catastrophic flexure damage. Therefore, there is a need to increase the ability of the flexure to counteract buckling load damage caused by stiction events and backward rotation events.

### SUMMARY OF THE INVENTION

In accordance with the present invention, apparatuses and a method are provided to limit and prevent buckling damage to a disk drive flexure when the read/write heads are subjected to high stiction loads and/or when backwards rotation of the disks occur with respect to the flexure. In general terms, the invention accomplishes this task by preventing large flexure motions by transferring some of the buckling loads experienced by the flexure to the stronger load beam.

As disk drives continue to become smaller in size, the flexure pitch and roll stiffness of the flexure must also be reduced to maintain required fly height performance. This reduced stiffness requirement in the flexures also decreases the buckling load carrying capability of the flexure since the flexures are made thinner. Accordingly, the reduction in the buckling load carrying capability of the flexure decreases the allowable stiction load of the head/disk interface. By providing a buckling limiter in accordance with the present invention, this allows the flexure to be designed for lower pitch and roll stiffness while increasing the load carrying capability of the flexure.

A buckling limiter or buckling limiting features in accordance with the present invention comprise structural components located on the flexure and load beam that prevent excessive displacement of the flexure in a direction of force applied by a buckling load. Excessive displacement which otherwise would cause damage to the flexure is prevented by the contact of a component on the flexure against a component on the load beam. In accordance with the preferred embodiments of the present invention as discussed further below, the buckling limiter of the present invention may include modifications made to both the load beam and flexure, or only modifications made to either the load beam or the flexure.

In accordance with preferred embodiments of the present invention, different design approaches are provided for creating the buckling limiter. In a first embodiment, the load beam includes a pair of stop extensions that extend substantially perpendicular to the plane of the load beam and beyond the plane of the flexure end placed in close proximity to the portion of the flexure carrying the slider. The stop extensions are positioned to contact the flexure and to prevent displacement of the flexure if a buckling load is experienced.

In a second embodiment of the present invention, a pocket is formed in the flexure directly adjacent to the load beam dimple. The pocket is sized such that the load beam dimple contacts the edges of the pocket in the event that a buckling load displaces the flexure.

In a third embodiment of the present invention, a tab is provided on the flexure that engages one or more features located at the distal end of the load beam to prevent backward flexure motion caused by a buckling load.

In a fourth embodiment of the present invention, a load beam feature in the form of a stop plate can be located to engage a feature on the flexure such as a flexure tab thereby providing buckling protection as well as shock protection by preventing the slider from making damaging contact against the disk.

In a fifth embodiment of the present invention, complementary features on both the load beam and the flexure can be provided to prevent backward motion of the flexure as well as providing shock protection by preventing the slider from making damaging contact against the disk. In this embodiment, the load beam is provided with a pair of opposing hook extensions, and the flexure is provided with complementary lateral tabs that nest within the hook extensions and the lateral tabs are prevented from excessive backward movement as well as movement toward the disk.

In accordance with the method of the present invention, a method of preventing buckling damage to a flexure of an actuator includes providing a buckling limiter, experiencing displacement of the flexure by a buckling load applied to the flexure, and preventing excessive displacement of the flexure by contact of a feature of the flexure against a feature of the stronger, stiffer load beam.

Other features and advantages of the present invention will become apparent from a review of the drawings, taken in conjunction with the detailed description.

### BRIEF DESCRIPTION OF THE DRAWINGS

FIG. 1 is a simplified plan view of a standard computer disk drive including an actuator for positioning of a slider on a magnetic storage disk;

FIG. 2 is fragmentary perspective view of an actuator detailing one particular construction of a flexure incorporating the buckling limiting feature of the present invention;

FIG. 3 is a reverse perspective view of the flexure illustrated in FIG. 1;

FIG. 4 is an enlarged fragmentary cross-sectional view taken along line 4-4 of FIG. 5 showing another embodiment of the buckling limiting feature of the present invention comprising a load beam tab and a pocket formed in the flexure;

FIG. 5 is a perspective view of the embodiment of FIG. 4 specifically illustrating the pocket formed in the flexure.

FIG. 6 is a fragmentary perspective view of another embodiment of the present invention illustrating another type of load beam and flexure design incorporating the buckling limiter feature of the present invention including a flexure limiter that engages load beam limiter tabs;

FIG. 7 is a perspective view of yet another embodiment of the present invention in the form of a stop feature incorporated on the load beam and engageable with a flexure limiter; and

FIG. 8 is a plan view of another embodiment of the present invention in the form of a different load beam and flexure design incorporating the buckling limiting features of the present invention comprising load beam hooks and lateral flexure tabs.

### DETAILED DESCRIPTION OF THE INVENTION

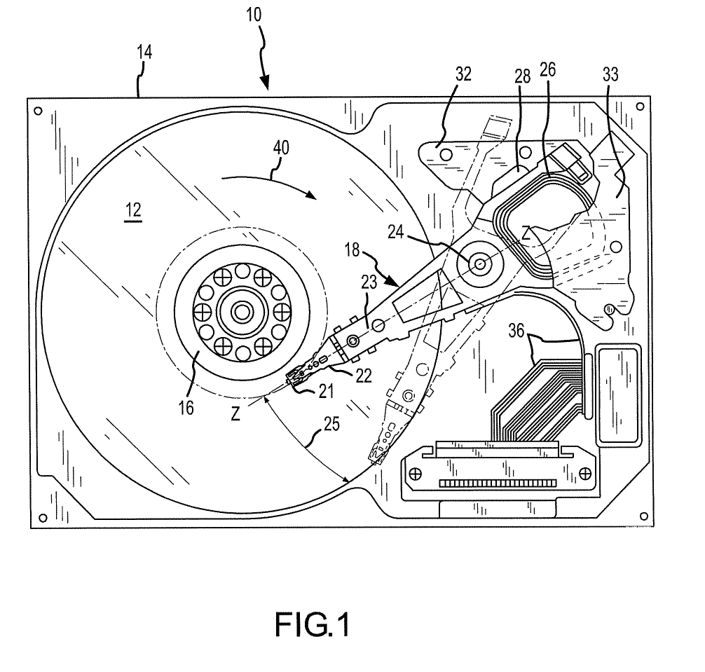

FIG. 1 illustrates a plan view of a common disk drive assembly 10 with the top cover removed. FIG. 1 is representative of any number of common disk drives. The disk drive assembly 10 includes at least one magnetic storage disk 12 typically having magnetic media on both the upper and lower surfaces thereof. The disk 12 along with other components of the disk drive are contained within a housing 14. The disk 12 is mounted over a hub 16 that is driven by a motor (not shown) enabling the disk to rotate at high revolutions per minute during operation. An actuator assembly 18 is shown rotatably mounted to an actuator pivot 24. A load beam 22 connects to an actuator arm 23. A flexure 21 attaches to the load beam 22. In solid lines, the actuator assembly 18 is shown parked over the landing zone. The actuator assembly is nearly symmetrical when viewed along longitudinal axis Z-Z. The landing zone of the disk may be allocated for takeoff and landing of the read/write heads during spin-up and spin-down of the disk. The actuator assembly 18 is rotated to a desired track by a voice coil motor 26. Accordingly, the actuator assembly 18 moves in an arcuate path 25 across the disk and is positioned over the desired tracks during operation. Each of the disk tracks on the disk 12 are formed concentrically so that the arcuate movement of the actuator assembly results in the head moving substantially laterally or transversely with respect to the direction in which the tracks extend. The voice coil 26 is immersed in a magnetic field generated by a magnet 28. Upper and lower cover plates 33 and 32 surround the magnet 28. An actuator control circuit (not shown) causes current flow in the voice coil motor 26 and ultimately controls the positioning of the actuator assembly by varying current through the voice coil. The dotted position of the actuator assembly 18 shows how the actuator may travel along path 25 by rotating about the actuator pivot point 24 in response to the voice coil motor 26. A flex cable 36 attaches to the actuator assembly which transfers electronic signals to and from a slider mounted to the flexure 21. The slider contains one or more read/write heads. The direction of spin of the disk 12 is shown in the clockwise rotation 40. Any counter-clockwise rotation of the disk 12 with respect to the actuator can cause buckling damage, as mentioned above.

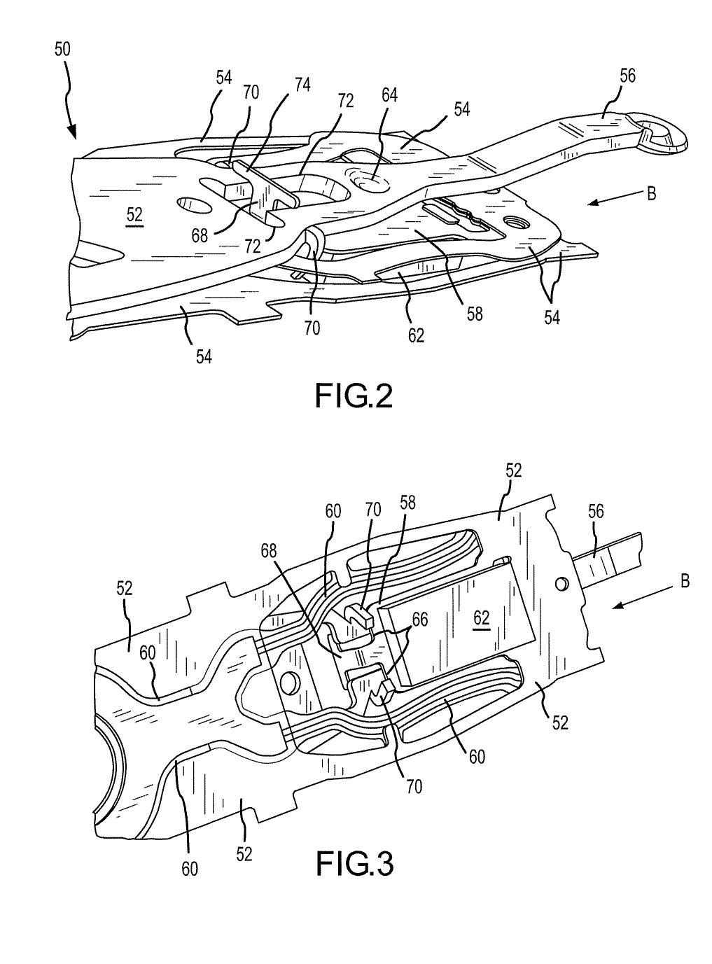

FIG. 2 illustrates a greatly enlarged fragmentary perspective view of an actuator assembly detailing one particular construction of a flexure/flexure incorporating the buckling limiting feature of the present invention. The distal portion of the actuator assembly 50 includes the load beam 52 and the flexure 54 which is secured to the load beam 50. In the example of FIG. 2, the load beam includes a load/unload tab 56 and a load beam dimple 64. The particular shape of the load beam 52 is dictated by the particular disk drive type, and it is understood that the load beam illustrated in FIG. 2 is simply representative of a known load beam configuration. The flexure 54 also simply represents one known type of flexure that is used in a disk drive, and the particular shape and configuration thereof may change depending upon a particular head stack assembly and disk pack configurations. The flexure 54 is also illustrated as having a U-shaped extension 58 that carries the slider 62. The slider 62 carries one or more read/write heads (not shown). Referring also to FIG. 3, the flexure 54 also includes a plurality of electrical connectors referred to as a circuit-in-flexure (CIS) 60 that provides the electrical connections between the end of the flexure and the printed circuit board assembly of the disk drive. As best seen in FIG. 3, the U-shaped extension 58 includes a flexure tab 68 that protrudes through a T-shaped opening 72 made in the load beam 52. The flexure tab 68 includes a transverse portion 74 that extends transversely with respect to a longitudinal axis of the actuator assembly.

The buckling limiting feature of the present invention in this first embodiment comprises a pair of load beam stop extensions 70 that extend through respective transverse openings in the flexure 54, and the load beam stop extensions 70 being located adjacent a shoulder 66 of the U-shaped extension 58. FIGS. 2 and 3 show the direction in which a buckling load B may be applied causing a buckling failure of the flexure. If the flexure were to receive a buckling load B, the flexure would be displaced in the direction of the arrow, thus causing the shoulder 66 to make contact with the stop extensions 70. The stop extensions 70 have the capability to therefore prevent the flexure from displacing in a manner that can cause damage to the flexure since the stop extensions 70 are able to effectively transfer the force of the buckling load to the stiffer and stronger load beam.

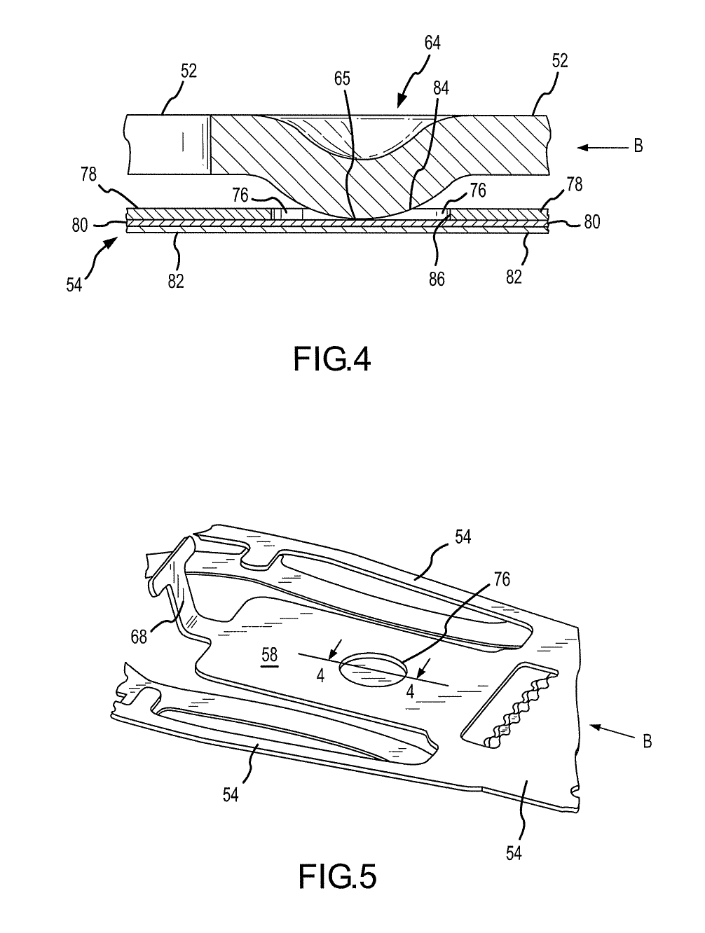

FIGS. 4 and 5 illustrate another embodiment of the present invention. Specifically, FIG. 4 is an enlarged fragmentary cross sectional view of a flexure incorporating another embodiment of the buckling limiting feature of the present invention comprising a load beam tab 64 and a pocket 76 formed in the flexure. FIG. 5 is a perspective view of the flexure illustrating the pocket formed in the flexure. The pocket 76 is formed directly below the load beam dimple 64 of the load beam 52. The pocket 76 does not need to be formed completely through the flexure and rather, the pocket 76 may be formed only through one or more selected layers of the flexure. One typical construction of a flexure utilizes a multi-layered configuration. Thus, the flexure may include various layers such as an upper stainless steel layer 78, a dielectric layer 80, and a copper trace layer 82. As shown in FIG. 4, the spacial relationship of the flexure 54 with respect to the load beam 52 allows the most protruding part 65 of the load beam dimple 64 to be inserted within the pocket 76 formed in the flexure. In the event a buckling load B is experienced by the flexure, the leading edge 86 of the pocket 76 would strike the area 84 on the load beam dimple to prevent the flexure from further displacing. The buckling limiting feature of this embodiment takes advantage of the existing load beam dimple 64 with only a modification made to the flexure. Depending upon the particular location of the load beam dimple 64, the pocket 76 may be formed at the corresponding location on the flexure where the load beam dimple 64 may constrain displacement of the flexure.

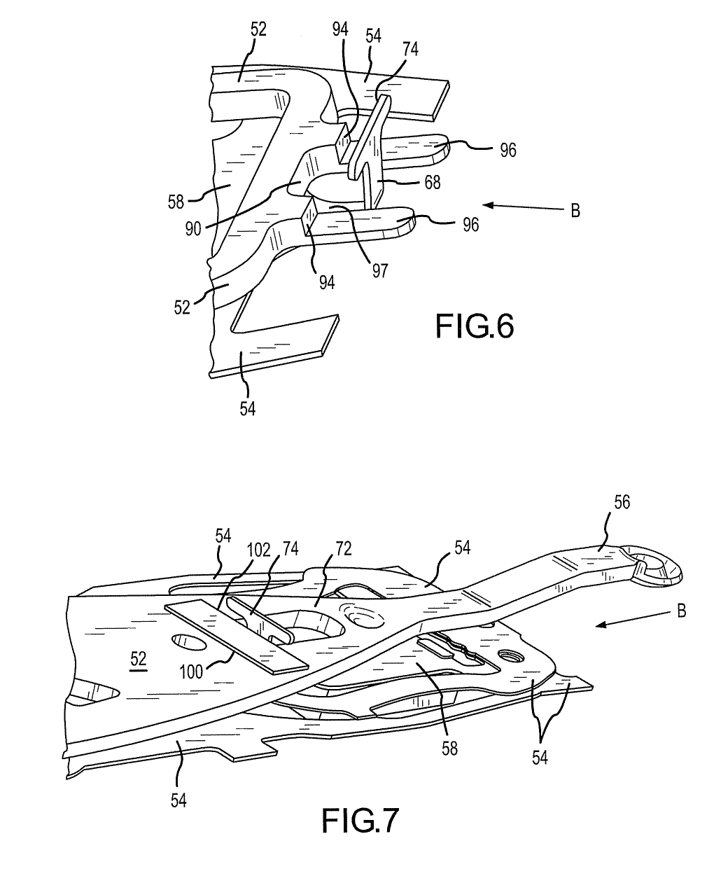

FIG. 6 illustrates yet another embodiment of the present invention. Specifically, FIG. 6 illustrates a very different design for both the load beam 52 and the flexure 54. As shown, the load beam 52 does not have a load/unload tab, and rather terminates with a pair of forked extensions 96 that extend distally beyond a contact surface 90 and flanges 94. Although the slider is not illustrated in FIG. 6, the slider would be positioned under the U-shaped extension 58. Additionally in FIG. 6, the flexure tab 68 and corresponding transverse portion 74 extend in a distal direction beyond the U-shaped extension 58, as opposed to extending proximally from the U-shaped extension as shown in the prior embodiments. The buckling limiting feature for the embodiment of FIG. 6 is achieved by contact of the flexure tab 68 against the contact surface 90 and/or contact of the transverse portion 74 against the flanges 94 in the event a buckling load B displaces the flexure 54. Depending upon the extent of the vertical separation or gap between the load beam 52 and the flexure 54, either the flexure tab 68 contacts the contact surface 90 or the transverse portion 74 of the flexure tab contacts the flanges 94 to prevent further displacement and damage to the flexure. The base 97 of the flexure tab is sized to only permit an acceptable amount of displacement of the flexure until the tab or transverse portion makes contact with the load beam.

FIG. 7 illustrates yet another embodiment of the present invention. In the example of FIG. 7, the solution to prevent buckling damage to the flexure by a buckling load B is achieved by simply adding a stop plate 100 adjacent the flexure tab 68 to prevent proximal displacement of the flexure tab 68. Specifically, excessive proximal displacement of the flexure causes the flexure tab 68 to contact the leading edge 102 of the stop plate 100. The stop plate 100 covers a portion of the T-shaped opening 72, thus also preventing the transverse portion 74 from rotating through the opening. Accordingly, the flexure is prevented from excessive displacement in the proximal direction, as well as in the orthogonal direction against an underlying disk.

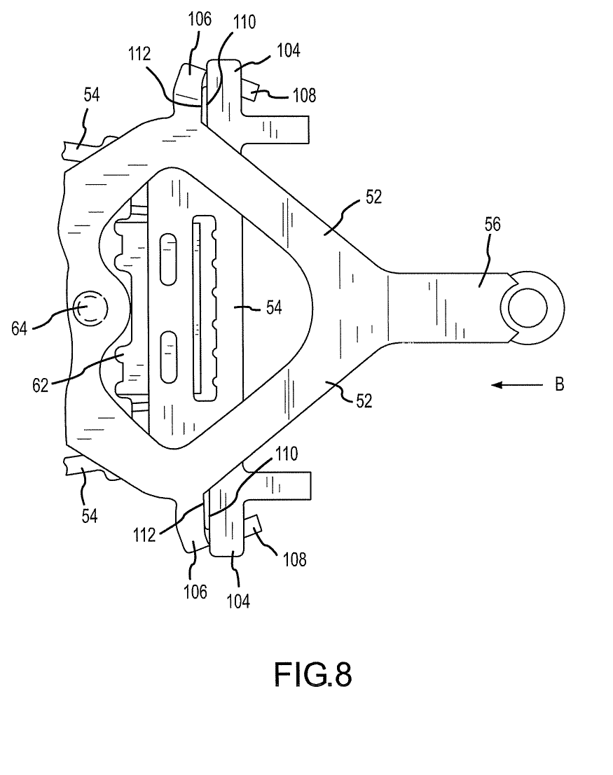

FIG. 8 illustrates yet another embodiment of the present invention. In FIG. 8, a very different shaped load beam 52 and flexure 54 are illustrated, like reference numbers in this embodiment also corresponding to the same elements in the prior embodiments. As shown, the load beam 52 terminates with a load/unload tab 56, and the flexure 54 carries the slider 62. The opposite lateral sides of the load beam 52 include respective hook extensions 106 that extend beyond the plane of the load beam 52. The hook extensions 106 terminate with distally extending tips 108. The flexure 54 comprises a pair of lateral tabs 104 that extend between the flexure 52 and the extension tips 108. This nested relationship between the positioning of the lateral tabs 104 and the hook extensions 106 prevent buckling damage to the flexure from the buckling load B by contact of the trailing edges 110 of the lateral tabs 104 against the leading edges 112 of the hook extensions 106. Also in this embodiment, excessive orthogonal displacement of the flexure is prevented by contact of the facing surfaces of the lateral tabs 104 and the tips 108.

In accordance with the method of the present invention, buckling damage to the flexure is prevented by provision of a buckling limiter wherein contact of a component of the flexure against a component of the load beam caused by the force of a buckling load causes the load to be at least partially transferred to the load beam. In accordance with the method, prevention of damaging contact of the slider against its corresponding disk is also prevented by also limiting the orthogonal or vertical displacement of the flexure with respect to the load beam by the same components used to prevent buckling damage.

The various preferred embodiments described above provide a number of solutions for preventing buckling damage to the flexure. In addition to prevention of buckling damage, some of the embodiments also prevent excessive orthogonal displacement of the flexure to prevent damaging contact of the slider against the disk that may be caused by shock events. The structural features provided to enable a buckling load to be transferred from the flexure to the load beam do not require extensive or substantial redesign of any of the actuator elements.

While the foregoing detailed description provides various preferred embodiments of the present invention, it shall be understood that various other modifications and changes may be made to the present invention that are within the spirit and scope of the present invention considering the scope of the claims appended hereto.

What is claimed is:

1. An actuator with features to prevent buckling damage to a flexure of the actuator, said actuator comprising:
a pivotal actuator arm;
a load beam attached to a distal end of the actuator arm;
a flexure secured to the load beam;
a slider mounted to the flexure, said slider including at least one read/write head for writing data to and reading data from a magnetic storage disk;
said load beam extending in a first plane;
said flexure extending in a second plane substantially parallel to said first plane; and
a first buckling limiter component formed on the flexure and a second buckling limiter component formed on said load beam, wherein displacement of said flexure in a direction of force of a buckling load applied to the flexure results in contact of the first component against the second component thereby delimiting displacement of the flexure.

2. An actuator, as claimed in claim 1, wherein:
said first buckling limiting component comprises a shoulder formed on a portion of said flexure, and said second buckling limiting component comprises at least one stop extension attached to said load beam and extending substantially perpendicular to said first plane and extending beyond said second plane, said stop extension position to extend through a first opening in said flexure and to delimit displacement of said flexure in the direction of the buckling load by contact of the stop extension against said shoulder.

3. An actuator, as claimed in claim 1, wherein:
said first buckling limiting component comprises a pocket formed in said flexure, and said second buckling limiting component comprising a dimple formed on said load beam, said pocket being positioned to abut said dimple of said load beam wherein a buckling load applied to said flexure causes said dimple of said load beam to contact a side edge of said pocket to delimit displacement of said flexure in the direction of the buckling load.

4. An actuator, as claimed in claim 1, wherein:
said first buckling limiter component comprises a flexure tab extending from said flexure and beyond said second plane, and said second buckling limiter component comprising a distal end of said load beam having a contact surface wherein said flexure tab contacts said contact surface to prevent displacement of the flexure in the direction of the buckling load applied to the flexure.

5. An actuator, as claimed in claim 1, wherein:
said first buckling limiter component comprises a flexure tab secured to said flexure and extending substantially perpendicular to said second plane and beyond said first plane, and said second buckling limiting feature comprises a stop mounted to said load beam and positioned adjacent said flexure tab, wherein a buckling load applied to said flexure causes a trailing edge of said flexure tab to contact a leading edge of said stop thereby delimiting displacement of the flexure in the direction of the buckling load.

6. An actuator, as claimed in claim 1, wherein:
said first buckling limiter feature comprises at least one lateral tab extending transversely with respect to a longitudinal axis of the actuator, and said second buckling limiting feature comprises at least one hook extension extending substantially perpendicular from said first plane and beyond said second plane, said at least one lateral tab placed in a nesting relationship with said at least one hook extension, wherein displacement of said flexure in the direction of the buckling load causes a trailing edge of said at least one lateral tab to contact a leading edge of said at least one hook extension thereby delimiting displacement of the flexure.

7. An actuator comprising:
a pivotal actuator arm;
a load beam attached to a distal end of the actuator arm;
a flexure secured to the load beam;
a slider mounted to the flexure, said slider including at least one read/write head for writing data to and reading data from a magnetic storage disk;
said load beam extending in a first plane;
said flexure extending in a second plane substantially parallel to said first plane; and
at least one stop extension attached to said load beam and extending substantially perpendicular to said first plane and extending beyond said second plane, said stop extension positioned to extend through a first opening in said flexure and to delimit displacement of said flexure in a direction of a buckling load applied to the flexure.

8. An actuator comprising:
a pivotal actuator arm;
a load beam attached to a distal end of the actuator arm;
a flexure secured to the load beam;
a slider mounted to the flexure, said slider including at least one read/write head for writing data to and reading data from a magnetic storage disk;
said load beam extending in a first plane;
said flexure extending in a second plane substantially parallel to said first plane;
said load beam having a dimple formed thereon that extends substantially orthogonal to said first plane; and
said flexure having a pocket formed therein, said pocket being positioned to abut said dimple of said load beam wherein a buckling load applied to said flexure causes said dimple of said load beam to contact a side edge of said pocket to delimit displacement of said flexure in a direction of the buckling load.

9. An actuator comprising:
a pivotal actuator arm;
a load beam attached to a distal end of the actuator arm;
a flexure secured to the load beam;
a slider mounted to the flexure, said slider including at least one read/write head for writing data to and reading data from a magnetic storage disk;
said load beam extending in a first plane;
said flexure extending in a second plane substantially parallel to said first plane;
said flexure further including a flexure tab extending substantially orthogonal to said second plane and said flexure tab extending beyond said first plane;
said distal end of said load beam having a contact surface in near-abutting relationship with said flexure tab wherein said flexure tab contacts said contact surface to prevent displacement of the flexure in the direction of a buckling load applied to said flexure.

10. An actuator, as claimed in claim 9, wherein:
said load beam further comprises a pair of extensions extending distally beyond said contact surface, and said flexure tab further having a transverse portion extending between said pair of extensions to prevent vertical displacement of said flexure with respect to said load beam.

11. An actuator comprising:
a pivotal actuator arm;
a load beam attached to a distal end of the actuator arm;
a flexure secured to the load beam;
a slider mounted to the flexure, said slider including at least one read/write head for writing data to and reading data from a magnetic storage disk;
said load beam extending in a first plane;
said flexure extending in a second plane substantially parallel to said first plane;
said flexure having a flexure tab extending substantially perpendicular to the second plane and extending beyond said first plane, said tab further including a transverse portion extending transversely with respect to a longitudinal axis of the actuator;
said load beam further having a stop mounted thereto and positioned adjacent said flexure tab wherein a buckling load applied to said flexure causes a trailing edge of said flexure tab to contact a leading edge of said stop thereby delimiting displacement of the flexure in the direction of the buckling load.

12. An actuator comprising:
a pivotal actuator arm;
a load beam attached to a distal end of the actuator arm;
a flexure secured to the load beam;
a slider mounted to the flexure, said slider including at least one read/write head for writing data to and reading data from a magnetic storage disk;
said load beam extending in a first plane;
said flexure extending in a second plane substantially parallel to said first plane;
said load beam further comprising at least one hook extension extending substantially perpendicular from first said plane and beyond said second plane; and
said flexure having at least one lateral tab extending transversely with respect to a longitudinal axis of the actuator and placed in a nesting relationship with said at least one hook extension, wherein displacement of said flexure in a direction of a buckling load causes a trailing edge of said at least one lateral tab to contact a leading edge of said at least one hook extension thereby delimiting displacement of the flexure.

13. A method of preventing buckling damage to a flexure of an actuator which receives a buckling load, said method comprising the steps of:
providing an actuator including a pivotal actuator arm, a load beam attached to a distal end of the actuator arm, a flexure secured to the load beam, and a slider mounted to the flexure, said slider including at least one read/write head for writing data to and reading data from a magnetic storage disk;
providing a first buckling limitor component formed on the flexure and a second buckling limitor component formed on the load beam; and
wherein displacement of said flexure in a direction of force of the buckling load applied to the flexure causes contact of the first component against the second component thereby delimiting displacement of the flexure.
